(19) United States
(12) Patent Application Publication
(10) Pub. No.: US 2018/0365742 A1
(43) Pub. Date: Dec. 20, 2018

(54) System for Data Analysis and Payment Expedition

(71) Applicant: Crystal A. Thomas, Houston, TX (US)

(72) Inventor: Crystal A. Thomas, Houston, TX (US)

(21) Appl. No.: 15/628,163

(22) Filed: Jun. 20, 2017

(51) Int. Cl. G06Q 30/04; G06Q 20/14; G06F 19/00; G06Q 50/22

(52) U.S. Cl. CPC G06Q 30/04; G06Q 50/22; G06F 19/328; G06Q 20/145

(57) ABSTRACT

An automated medical and/or dental tool that preforms an analytic process within a system database to determine if the medical or dental service billed by a provider meets payer reimbursement requirements and medical necessity, thus eliminating EDI usage, transaction costs and utilization of a clearinghouse to conduct a primary claim/encounter analysis. This tool will also assist dental providers in determining if a medical HCPC or CPT can be billed to the medical payer in addition or in substitution to the billed dental service submitted to the dental payer.

### CROSS-REFERENCE TO RELATED APPLICATIONS

Not applicable.

### STATEMENT REGARDING FEDERALLY SPONSORED RESEARCH

Not applicable.

### BACKGROUND

Provider payment can be a slow and nonfruitful process. The present invention expedites provider payment therein potentially increasing service provider revenue.

In some embodiments, the present invention is a system and a method of performing an analytic process within a system database to determine if the services rendered meet payer reimbursement and medical necessity requirements, thus eliminating the transaction cost and utilization of the clearinghouse to conduct a primary claim analysis. In some embodiments, the analytic process within the system database will also assist Dentist in determining if a medical HCPC or CPT can be billed to the medical payer in addition to or supplemental to the dental payer for the dental service rendered. Specific terms, are defined later in this document.

The present invention is distinguished from the following art in many ways:

US20010027403 is entitled “System and method for employing targeted messaging in connection with the submitting of an insurance claim.” The present invention is distinguished from this patent because the present invention enables the provider to select the service(s) they rendered along with the corresponding diagnosis/diagnoses then conducts a primary analysis on the service provided and diagnosis. Medical necessity questions then populate for the provider to answer to ensure payer reimbursement and medical necessity requirements are met prior to claim submission. This patent discloses a system and method for delivery of information, such as advertisements, coupons, informative medical information, etc. Wherein, this further information is selected for delivery to the insured and/or provider based upon information submitted. For example, if the submitted information indicates that the insurance claim is related to prenatal care for some pregnant women, coupons for baby supplies. In several embodiments, the present invention addresses expedited systems for processing services for payment.

US20030149594 is entitled “System and method for secure highway for real time preadjudication and payment of medical claims.” This patent provides a provider with a line of credit, with funding determined using risk analysis tools and utilizing a recorded security interest; collecting payment from the payer via a secured environment; and repaying the line of credit from the collected. The present invention does not address any credit lines at all.

US20040107125 is entitled “Business alliance identification in a web architecture.” The present invention is distinguished from this patent because the present invention enables the provider to select the service(s) they rendered along with the corresponding diagnosis/diagnoses then conducts a primary analysis on the service provided and diagnosis. Medical necessity questions then populate for the provider to answer to ensure payer reimbursement and medical necessity requirements are met prior to claim submission.

US20050288972 is entitled “Direct connectivity system for healthcare administrative transactions.” The present invention will leverage provider manuals and payer logic to ensure all payer requirements/verbiage is utilized in order to meet payer specific reimbursement requirements during an embedded primary scrub eliminating EDI and clearinghouse transactions to conduct the primary scrub. This patent is a direct connectivity system that provides automated healthcare administrative transaction submission, including claim submission, eligibility verification and claim status, from healthcare service providers directly to payers.

US20050065816 is entitled “Healthcare management information system” Patent 2005/0065816 provides a method, system, data structure and computer program product for generating a visual compliance display. The present invention is focused on expediting and streamlining payment and data processing for service providers. The present invention can leverage provider manuals and payer logic to ensure all payer requirements/verbiage is utilized in order to meet payer specific reimbursement requirements during an embedded primary scrub eliminating EDI and clearinghouse transactions to conduct the primary scrub. The present invention is distinguished from this patent because the present invention enables the provider to select the service(s) they rendered along with the corresponding diagnosis/diagnoses then conducts a primary analysis on the service provided and diagnosis. Medical necessity questions then populate for the provider to answer to ensure payer reimbursement and medical necessity requirements are met prior to claim submission.

US20060047539 is entitled “Healthcare administration transaction method and system for the same.” The present invention will leverage provider manuals and payer logic to ensure all payer requirements/verbiage is utilized in order to meet payer specific reimbursement requirements during an embedded primary scrub eliminating EDI and clearinghouse transactions to conduct the primary scrub.

US20070265887 is entitled “Integrated electronic business systems.” The present invention is distinguished from this patent because the present invention enables the provider to select the service(s) they rendered along with the corresponding diagnosis/diagnoses then conducts a primary analysis on the service provided and diagnosis. Medical necessity questions then populate for the provider to answer to ensure payer reimbursement and medical necessity requirements are met prior to claim submission. This patent is a system and method for optimizing healthcare remittance processing which includes a network computing device that provides a user interface and access to healthcare claims and remittance data prepared by a system.

US20090157435 is entitled “System and method of accelerated health care claim payments.” In this patent, the provider's dictation/office note is not reviewed to determine if the correct verbiage was utilized to meet the payer's guidelines or medical necessity. This patent also functions as a method of accelerating a health care claim payment by filtering a claim to determine whether a claim is eligible for accelerated claim payment. A payment amount for a claim is determined by a computing device retaining a provider level adjustment. The present invention is distinguished from this patent because the present invention enables the provider to select the service(s) they rendered along with the corresponding diagnosis/diagnoses then conducts a primary analysis on the service provided and diagnosis. Medical necessity questions then populate for the provider to answer to ensure payer reimbursement and medical necessity requirements are met prior to claim submission.

US20100131299 is entitled “System for communication of health care data.” Unlike this patent, two computer systems will not be needed for the present invention to operate, with the present invention, to achieve our overall objective. Rules and edits will be embedded in the software and chain-link left open for imports and exports. This patent functions as a communication apparatus which utilizes two computer systems and rules engine. The first computer in this patent stores healthcare data, while the second computer system is in operable communication that is configured to extract the health care data from the first computer system. The rules engine is utilized to normalize the extracted health care data to a predefined format.

US20110066445 is entitled “Systems, Apparatus, and Methods for advancing payment tracking for healthcare claims.” The present invention can leverage provider manuals and payer logic to ensure all payer requirements/verbiage is utilized in order to meet payer specific reimbursement requirements during an embedded primary scrub eliminating EDI and clearinghouse transactions to conduct the primary scrub. This patent provides a payment status message to the provider for at least one submitted claim to indicate a past due payment or a pending payment approaching the expected remittance payment date for a submitted claim. The present invention is distinguished from this patent because the present invention enables the provider to select the service(s) they rendered along with the corresponding diagnosis/diagnoses then conducts a primary analysis on the service provided and diagnosis. Medical necessity questions then populate for the provider to answer to ensure payer reimbursement and medical necessity requirements are met prior to claim submission.

US20120022887 is entitled “System and method for optimizing healthcare remittance processing.” The present invention can leverage provider manuals and payer logic to ensure all payer requirements/verbiage is utilized in order to meet payer specific reimbursement requirements during an embedded primary scrub eliminating EDI and clearinghouse transactions to conduct the primary scrub. This patent is a process that comprises a remittance component for automatically converting paper and electronic remittance and payment data into validated electronic information that is compliant with HIPAA Administrative Simplification standards. The present invention is distinguished from this patent because the present invention enables the provider to select the service(s) they rendered along with the corresponding diagnosis/diagnoses then conducts a primary analysis on the service provided and diagnosis. Medical necessity questions then populate for the provider to answer to ensure payer reimbursement and medical necessity requirements are met prior to claim submission.

US20130151265 is entitled “Automated medical billing system for radiation therapies.” This patent's scope is limited to radiation therapy. The patent is a system that suggests billing codes based on analysis of the treatment plan and the work done. The present invention is distinguished from this patent because the present invention scope is not limited to only radiation therapy and enables the provider to select the service(s) they rendered along with the corresponding diagnosis/diagnoses then conducts a primary analysis on the service provided and diagnosis. Medical necessity questions then populate for the provider to answer to ensure payer reimbursement and medical necessity requirements are met prior to claim submission.

US20140088985 is entitled “Providing healthcare solution and workflow management.” The present invention is distinguished from this patent because the present invention encompasses both medical and dentistry services and enables the provider to select the service(s) they rendered along with the corresponding diagnosis/diagnoses then conducts a primary analysis on the service provided and diagnosis to determine if medical necessity and payer reimbursement requirements are met. A series of questions then populate for the provider to answer to ensure LCD, NCD, payer reimbursement and medical necessity requirements are met prior to claim submission. The present invention can leverage provider manuals and payer logic to ensure all payer requirements/verbiage is utilized. This invention also assists in determining if a HCPC or CPT can be billed in addition or substitution of a CDT. This patent is an operating and computing device that responds to an input physician identifier and an input diagnosis identifier, and selected treatment protocol. The patent produces an order corresponding to the treatment protocol on behalf of a patient as well as other embodiments.

US20130246094 is entitled “Medical services claim publication management system and method.” In this patent claims are aggregated into a single file and submitted for payment electronically. If a file level rejection occurs, rejected claims are removed and the single file is reformed and resubmitted. This patent functions as a claims management system that allows a connection with a healthcare service provider system. This patent does not allow the provider to select the service(s) they rendered along with the corresponding diagnosis/diagnoses as the present invention does. Nor does the patent populate a series of questions for the provider to answer to ensure LCD, NCD, payer reimbursement and medical necessity requirements are met prior to claim submission.

US20140195265 is entitled “Method for reimbursement of healthcare services.” This patent does not allow the provider to select the service(s) they rendered along with the corresponding diagnosis/diagnoses as the present invention does. Nor does the patent populate a series of questions for the provider to answer to ensure LCD, NCD, payer reimbursement and medical necessity requirements are met prior to claim submission. This patent is a method that relates to improving healthcare reimbursement procedures such as providing a data resource, verification and retrieval for data.

US20170004266 is entitled “Method of administering a healthcare code reporting” This patent does not allow the provider to select the service(s) they rendered along with the corresponding diagnosis/diagnoses as the present invention does. Nor does the patent populate a series of questions for the provider to answer to ensure LCD, NCD, payer reimbursement and medical necessity requirements are met prior to claim submission. This patent is a method that allows users to identify data such as diagnosis codes and or “HCC” by entering search data.

US20170039330 is entitled “System and method for decentralized autonomous healthcare economy platforms” “This patent is a system and method that aggregates all healthcare data into a global-theoretic topology and process the data via hybrid federated and peer to peer distribution processing architecture.” This patent does not allow the provider to select the service(s) they rendered along with the corresponding diagnosis/diagnoses as the present invention does. Nor does the patent populate a series of questions for the provider to answer to ensure LCD, NCD, payer reimbursement and medical necessity requirements are met prior to claim submission.

U.S. Pat. No. 5,832,447 is entitled “Automated system and method for providing real-time verification of health insurance eligibility.” This patent determines real-time whether a patient at a healthcare facility has health insurance coverage. This patent does not allow the provider to select the service(s) they rendered along with the corresponding diagnosis/diagnoses as the present invention does. Nor does the patent populate a series of questions for the provider to answer to ensure LCD, NCD, payer reimbursement and medical necessity requirements are met prior to claim submission. Overall objectives are different.

U.S. Pat. No. 6,343,271 is entitled “Electronic Creation/Submission and PYMT of Ins. Claims” is a claim processing system that allows the health care provider to access the patient's benefits information relating to the contractual arrangement between the patient, the health care provider, and insurer before the health care provider submits the claims for payment. The system allows a claim to be pretested to determine whether the claim is to be automatically adjudicated or manually adjudicated. The patent also executes an electronic fund transfer on insurance claims that have been adjudicated and approved. The provider's dictation/office note is not reviewed to determine if the correct verbiage was utilized to meet the payer's guidelines or medical necessity. This patent does not allow the provider to select the service(s) they rendered along with the corresponding diagnosis/diagnoses as the present invention does. Nor does the patent populate a series of questions for the provider to answer to ensure LCD, NCD, payer reimbursement and medical necessity requirements are met prior to claim submission. The present invention can leverage provider manuals and payer logic to ensure all payer requirements/verbiage is utilized. This invention also assists in determining if a HCPC or CPT can be billed in addition or substitution of a CDT. The present invention is distinguished from this patent because the present invention encompasses both medical and dentistry services.

U.S. Pat. No. 6,343,310 entitled “Attachment integrated claims system and operating method therefor.” This patent is a system and corresponding method implemented by software loaded onto the system for processing textual messages which are integrated with one or more attachments. This patent does not allow the provider to select the service(s) they rendered along with the corresponding diagnosis/diagnoses as the present invention does. Nor does the patent populate a series of questions for the provider to answer to ensure LCD, NCD, payer reimbursement and medical necessity requirements are met prior to claim submission. The present invention can leverage provider manuals and payer logic to ensure all payer requirements/verbiage is utilized. This invention also assists in determining if a HCPC or CPT can be billed in addition to or in substitution of a CDT.

U.S. Pat. No. 6,578,015 is entitled “Methods, devices and systems for electronic bill presentment and payment.” This particular patent is a computer-implemented method of presenting an electronic bill from a biller to a customer over a computer. This patent does not allow the provider to select the service(s) they rendered along with the corresponding diagnosis/diagnoses as the present invention does. Nor does the patent populate a series of questions for the provider to answer to ensure LCD, NCD, payer reimbursement and medical necessity requirements are met prior to claim submission. The present invention can leverage provider manuals and payer logic to ensure all payer requirements/verbiage is utilized. This invention also assists in determining if a HCPC or CPT can be billed in addition to or in substitution of a CDT.

U.S. Pat. No. 7,340,426 is entitled “Event-triggered transaction processing for electronic data interchange.” This patent defines an “event” as a computer record corresponding to a business transaction or an action taken in accordance with a business transaction. The present invention serves as an internal database assistant decision maker in helping determine if the service(s) along with the corresponding diagnosis/diagnoses selected by a provider meet payer reimbursement and medical necessity requirements prior to claim submission or business transactions via electronic data exchange. This patent reads that “business rule may then be entered into the computer system by a user via a user interface and subsequently stored in a database,” while the present invention's system database utilizes reimbursement logic built within the present database as well as other outsourced data that may be integrated or retrieved via the internet to conduct a primary analysis prior to claim submission or business transactions via electronic data exchange.

U.S. Pat. No. 7,409,632 is entitled “Classifying, disabling and transmitting form fields in response to data entry” is a system and corresponding method implemented by software loaded onto the system for processing textual messages which are integrated with one or more attachments. The present invention is distinguished from this patent because the present invention enables the provider to select the service(s) they rendered along with the corresponding diagnosis/diagnoses then conducts a primary analysis on the service provided and diagnosis. Medical necessity questions then populate for the provider to answer to ensure payer reimbursement and medical necessity requirements are met prior to claim submission to the clearinghouse or payer.

U.S. Pat. No. 7,451,107 is entitled “Business to business electronic commerce clearinghouse.” The patent relates generally to electronic commerce, and more specifically, to business-to-business electronic commerce and identifies the need for integrating the traditional point-to-point business supply chain at a clearinghouse. The present invention is distinguished from this patent because the present invention enables the provider to select the service(s) they rendered along with the corresponding diagnosis/diagnoses then conducts a primary analysis on the service provided and diagnosis. Medical necessity questions then populate for the provider to answer to ensure payer reimbursement and medical necessity requirements are met prior to claim submission to the clearinghouse or payer.

U.S. Pat. No. 7,617,116 is entitled “Practice management and billing automation system.” This patent does not populate a series of questions for the provider to answer to ensure LCD, NCD, payer reimbursement and medical necessity requirements are met prior to claim submission. The present invention can leverage provider manuals and payer logic to ensure all payer requirements/verbiage is utilized. This invention also assists in determining if a HCPC or CPT can be billed in addition to or in substitution of a CDT. The present invention is distinguished from this patent because this patent utilizes a “HOLD” status to denote that a claim cannot be transmitted to a payer. The patent does not indicate the true reason as to why the claim cannot be transmitted to the payer, it only provides a generic claim status reason which requires a provider's office to do additional research and or actions to determine the true reason for the hold to resolve the “HOLD” status. This patent also embodies communication to a CBO (Central Billing Office) where the present invention does not limit communication to a CBOs, but allows communication to a broader scope of end-users.

U.S. Pat. No. 7,805,322 is entitled “Healthcare eligibility and benefits data system.” This patent does not allow the provider to select the service(s) they rendered along with the corresponding diagnosis/diagnoses as the present invention does. Nor does the patent populate a series of questions for the provider to answer to ensure LCD. NCD, payer reimbursement and medical necessity requirements are met prior to claim submission. The present invention can leverage provider manuals and payer logic to ensure all payer requirements/verbiage is utilized in the form of dictation or a chart note. This invention also assists in determining if a HCPC or CPT can be billed in addition to or in substitution of a CDT. This patent also embodied the use of receiving emails “ERA E-mail Notification and Secure FTP (mailbox) Delivery” via a link, the provider where end users are required to “opt in” to utilize this service.

U.S. Pat. No. 8,447,627 is entitled “Medical services claim management system and method.” This patent does not allow the provider to select the service(s) they rendered along with the corresponding diagnosis/diagnoses as the present invention does. Nor does the patent populate a series of questions for the provider to answer to ensure LCD, NCD, payer reimbursement and medical necessity requirements are met prior to claim submission. The present invention can leverage provider manuals and payer logic to ensure all payer requirements/verbiage is utilized in the form of dictation or a chart note. This invention also assists in determining if a HCPC or CPT can be billed in addition to or in substitution of a CDT. This patent is a method/system for managing requests by a medical services provider for payment from a payer. This patent only encompasses the submission of a claim to the payer and the process once delivery of the explanation of benefits relating to a claim is received.

U.S. Pat. No. 8,626,534 is entitled “System for communication of health care data.” This invention assists in determining if a HCPC or CPT can be billed in addition to or in substitution of a CDT. This patent does not allow the provider to select the service(s) they rendered along with the corresponding diagnosis/diagnoses as the present invention does. Nor does the patent populate a series of questions for the provider to answer to ensure LCD, NCD, payer reimbursement and medical necessity requirements are met prior to claim submission. The present invention can leverage provider manuals and payer logic to ensure all payer requirements/verbiage is utilized in the form of dictation or a chart note. This patent is an apparatus for communicating health care data from a sender to a receiver is provided. It relates generally to a computerized system that establishes connectivity between interested parties in the health care industry for the administration of healthcare services. More particularly, the patent relates to a system for the normalization of health care data of various formats and exchanging the data in normalized form between insurers and participants, such as providers, patients, and employers.

U.S. Pat. No. 8,781,853 is entitled “Integrated medical software system with location driven bill coding.” The predefined templates in this patent are not based on the insurance associated to the patient, therefore the templates do not leverage the payer's verbiage to meet medical necessity. This system does not allow providers to determine if both medical and dental insurance can be billed based on the services provided, thus increasing net revenue. Nor does the patent populate a series of questions for the provider to answer to ensure LCD, NCD, payer reimbursement and medical necessity requirements are met prior to claim submission. This patent suggests ICD, CPT and E/M (evaluation and management) codes based on the encounter documentation completed by the clinician.

### SUMMARY

In some embodiments, it is an object of the present invention to increase revenue, decrease overhead and optimize an organization's system database and improve organizations manual processes and operations.

In one embodiment of the present invention, an embedded primary analysis of a medical or dental claim/encounter is conducted without the use of EDI transactions or a clearinghouse to ensure payer reimbursement requirements and medical necessity are met.

In one embodiment, the object of the present invention is to assist dental providers in determining if a medical HCPC or CPT can be billed to the medical payer in addition to or in substitution to the billed medical or dental service submitted to the dental payer. In another embodiment of the present invention, the invention generates a series of questions a provider must answer once they have selected the rendered billable service they have performed on their patient. Based on the providers answers the present invention will determine if the service selected meets, or does not meet, payer reimbursement requirements and medical necessity and will either generate a medical or dental claim for submission to the clearinghouse or payer for claim adjudication or will route the encounter appropriately within the system database for review and appropriate coding on the selected rendered billable service.

In one embodiment of the present invention, if the claim/encounter meets payer reimbursement requirements and medical necessity the tool will also auto-populate a template based on the payer guidelines verbiage needed to meet medical necessity documentation requirements in the form of dictation or chart note.

In some embodiments, the present invention is an improved billing system and method comprising the steps of: rendering service from a provider to a patient; selecting the billing from the CPT/HCPC by a provider; utilizing a system database to analyze selected CPT/HCPC and populate medical questions for a provider to answer to determine if said service meets a medical necessity. In some embodiments, the method is further comprising the step of: answering all populated medical questions with “yes,” and filing a medical bill to the medical payer. In some embodiments, the method is further comprising the step of: answering at least one populated medical question with “no”; determining by the system database that the CPT/HCPC selected does not meet payer guidelines; rerouting to the work que for review and appropriate coding to bill; utilizing a system database to analyze selected CPT/HCPC and populate medical questions for a provider to answer to determine if said service meets a medical necessity; repeating said steps until answering all populated medical questions with “yes,” and filing a medical bill to the medical payer.

In several embodiments, the present invention is an improved billing system and method comprising the steps of: rendering service from a provider to a patient; selection by the provider the billing from the CPT and or HCPC; analyzing by the system database of the selected CPT and or HCPC and populating medical questions for provider to answer to determine if a medical HCPC/CPT can be billed in addition to CDT. In several embodiments, the method has the further step comprising: answering by the provider of all medical questions with “yes”; populating the HCPC/CPT to provide to select service performed; selection of CPT/HCPC for medical service provider and then medical claim is filed to medical payer; and generating the dental charge and claim which is filed to dental payer. In several embodiments, the method has the additional step of answering at least one of the questions with “no”; and dropping the dental charge and the claim is filed to dental payer.

In several embodiments, the present invention is an improved billing system and method comprising the steps of: rendering service to a patient from a provider, selecting a billing service by the provider; analyzing by the system database of the selected service and populating medical questions for provider to answer to determine if service meets medical necessity. In several embodiments, the method has a further step comprising: answering all questions with “yes”; and filing professional medical bill or dental bill to payer. In several embodiments, the method has the further steps comprising: answering at least one question “no”; determining by the system database if the service selected does not meet payer guidelines and routes to work queue for review and appropriate coding to bill; and analysis of process cycle the system database of the selected service and populated medical questions for provider to answer to determine if service meets medical necessity.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIG. 1 is a flow diagram of one embodiment of the present invention.

FIG. 2 is a flow diagram of one embodiment of the present invention.

FIG. 3 is a flow diagram of one embodiment of the present invention.

FIG. 4 is a flow diagram of one embodiment of the present invention.

FIG. 5 is a flow diagram of one embodiment of the present invention.

FIG. 6 is a flow diagram of one embodiment of the present invention.

### DETAILED DESCRIPTION

One or more illustrative embodiments incorporating the invention disclosed herein are presented below. Applicant has created a revolutionary and novel system for data analysis and payment expedition and method of use of the same.

In the following description, certain details are set forth such as specific quantities, sizes, etc. so as to provide a thorough understanding of the present embodiments disclosed herein. However, it will be evident to those of ordinary skill in the art that the present disclosure may be practiced without such specific details. In many cases, details concerning such considerations and the like have been omitted inasmuch as such details are not necessary to obtain a complete understanding of the present disclosure and are within the skills of persons of ordinary skill in the relevant art.

Referring to the drawings in general, it will be understood that the illustrations are for the purpose of describing particular embodiments of the disclosure and are not intended to be limiting thereto. Drawings are not necessarily to scale and arrangements of specific units in the drawings can vary.

While most of the terms used herein will be recognizable to those of ordinary skill in the art, it should be understood, however, that when not explicitly defined, terms should be interpreted as adopting a meaning presently accepted by those of ordinary skill in the art. In cases where the construction of a term would render it meaningless or essentially meaningless, the definition should be taken from Webster's Dictionary, 11th Edition, 2008. Definitions and/or interpretations should not be incorporated from other patent applications, patents, or publications, related or not, unless specifically stated in this specification or if the incorporation is necessary for maintaining validity. Specifically defined terms include, but are not limited to:

“CDT” or “Current Dental Terminology” as defined herein, can be defined as, a coding system that is used to report dental, surgical, and diagnostic procedures and services of the American Dental Association.

“Clearinghouse” as defined herein, can be defined, in medical/dental billing, as companies that function as intermediaries who forward claims information from healthcare/dental providers to insurance payers.

“CMS 1500” as defined herein, can be defined as the uniform professional health care insurance claim form in the U.S., previously known as the HCFA-1500 claim form.

“CPT” or “Current Procedural Terminology” as defined herein, can be defined as, a medical code set that is used to report medical, surgical, and diagnostic procedures and services to entities such as physicians, health insurance companies and accreditation organizations.

“Dental Claim” as defined herein, can be a form, paper or electronic, used to report dental procedures to a third-party payer in order to file for benefits under a dental benefit program.

“EDI” or “Electronic Data Interchange,” as defined herein, can be the computer-to-computer exchange of business documents in a standard electronic format between business partners.

“Encounter” as defined herein, is a health care contact between the patient and the provider who is responsible for diagnosing and treating the patient.

“FSC/FIN” or “Financial Status Classification or Financial Indictor Number” as defined herein is an item mapped to the Payer within a SYSTEM DATABASE.

“HCPC” or “Healthcare Common Procedure Coding System” as defined herein is a set of health care procedure codes based on the American Medical Association's Current Procedural Terminology (CPT).

“Medical Necessity,” as defined herein, is accepted health care/dental services and supplies provided by health care/dental entities, appropriate to the evaluation and treatment of a disease, condition, illness or injury and consistent with the applicable standard of care.

“Payer,” as defined herein, is the responsible party for paying the bill, satisfying the claim, or settling a financial obligation. They can also be the medical or dental carrier.

“Payer Edits,” as defined herein is the data elements/information that determines if a medical or dental claim can be adjudicated by the payer.

“Payer Guideline(s)” as defined herein are the billing guidelines in the payer's provider manual.

“System Database” or “Practice Management Software” as defined herein, is the category of healthcare software that deals with the day-to-day operations of a medical practice. Such software frequently allows users to capture patient demographics, clinical orders, clinical documentation, clinical results, other EMR functionalities, schedule appointments, maintain lists of insurance payers, perform billing tasks, and generate reports.

“Primary Claim Analysis” as defined herein is the charges/services ran against programmed rules embedded in System Database that identifies payer edits without utilizing a clearinghouse.

“Provider” as defined herein, is a term used for health/dental professionals who provide/bill health care/dental services.

“Registration,” as defined herein, is the process in which the following data elements are captured and entered into the system database: Patient Demographics i.e. patient's name, date of birth, social security number, address, telephone number. Insurance/Payer Information i.e. insurance carrier identification number, policy number, member ID, group number, subscriber number, subscriber name, subscriber relationship, claim submission address, insurance carrier/payer phone number and insurance carrier/payer address.

“Secondary Claim Analysis,” as defined herein, is a clearinghouse check of the claim for errors and verify that it is compatible with the payer software. This is transaction based.

“Service(s) Rendered,” as defined herein is the CPT, CDT or HCPC billed by the rendering provider.

“Table Data,” as defined herein can be data arranged in rows and columns and used in databases to store information.

Certain terms are used in the following description and claims to refer to particular system components. As one skilled in the art will appreciate, different persons may refer to a component by different names. This document does not intend to distinguish between components that differ in name but not function. The drawing figures are not necessarily to scale. Certain features of the invention may be shown exaggerated in scale or in somewhat schematic form, and some details of conventional elements may not be shown, all in the interest of clarity and conciseness.

Although several preferred embodiments of the present invention have been described in detail herein, the invention is not limited hereto. It will be appreciated by those having ordinary skill in the art that various modifications can be made without materially departing from the novel and advantageous teachings of the invention. Accordingly, the embodiments disclosed herein are by way of example. It is to be understood that the scope of the invention is not to be limited thereby.

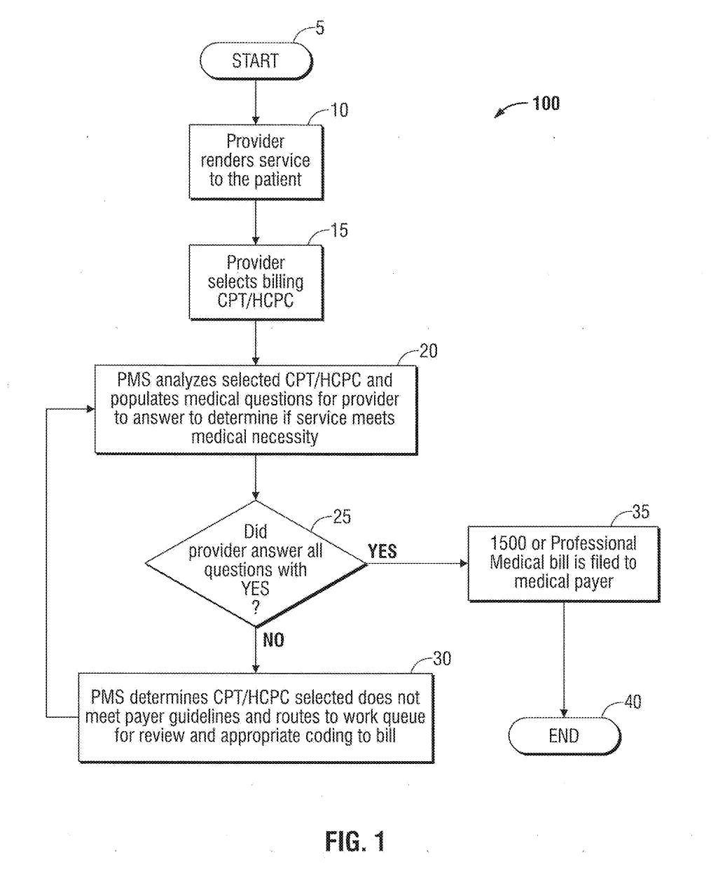

FIG. 1 illustrates one embodiment of the present invention. As shown, the inventive process 100 commences 5 with the build of different modules and or tables a system database i.e. claimant, patient, payer or insurance carrier, service, HCPC, CPT, CDT, clinical, financial, benefit policy. Claimant, patient, payer/insurance carrier, and/or benefit policy tables are then built within the system database with specific reimbursement and/or medical necessity logic based on the associated policy/payer/payee reimbursement requirement. Each claimant, patient, and/or payer/insurance carrier built/loaded, added, entered is assigned a system ID or other type of aliases based on the table association within the system database. A claimant, patient, and/or payer/insurance carrier is registered into the system database by an end-user. The claimant, patient, and/or payer/insurance carrier or other type of payer aliases is mapped to the appropriate system ID within the system database. Client/organization utilizing system database provides service to their customer as per their customer scope 10. Subsequent to this, step the provider selects the billing from the CPT/HCPC 15. In several embodiments after this step, the System Database analyzes the selected CPT/HCPC 15 and populates medical questions for provider to answer to determine if service meets medical necessity 20.

In many embodiments, if the provider answers all questions with “yes” 25, then the professional medical bill is filed to the medical payer 35 and the process is ended 40. If the provider does not answer all questions with a “yes” 35 then the System Database determines the CPT/HCPC selected does not meet payer guidelines and routes to the work que for review and appropriate coding to bill 30. After this step, the System Database is rerouted and the System Database analyzes the selected CPT/HCPC 15 and populates medical questions for provider to answer to determine if service meets medical necessity 20. Ergo, steps 20, 25, and 30 are repeated until all answers for step 25 are “yes” and then step 35 is actuated.

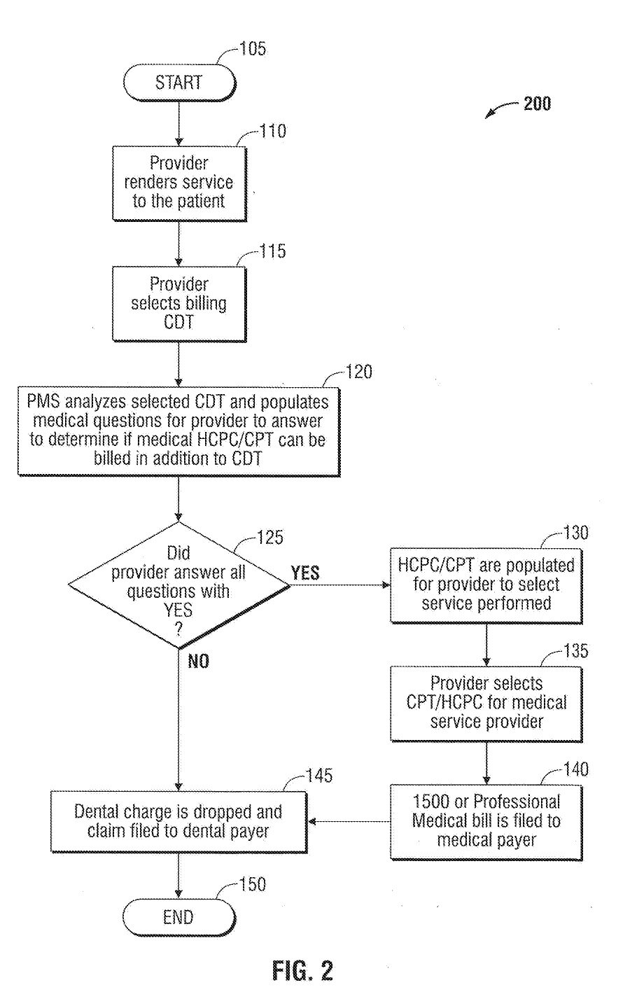

FIG. 2 illustrates one embodiment of the present invention. As shown, the inventive process 200 commences 105 when a provider renders service to a patient 110. Subsequent to this step the provider selects the billing from the CDT 115. In several embodiments after this step, the System Database analyzes the selected CDT 115 and populates medical questions for provider to answer to determine if medical HCPC/CPT can be billed in addition or in substitution to CDT 20.

In many embodiments, if the provider answers all questions with “yes” 125, then HCPC/CPT are populated to provide select service performed 130. At this time, in several embodiments, provide selects CPT/HCPC for medical service provider 135 and then medical claim is filed to medical payer 140. After this, in many embodiments, the medical charge is generated and claim is filed to dental payer 145. If provider did not answer all of the questions with “yes” 125 then the dental charge is generated and claim is filed only to dental payer 145. In many embodiments, after the dental charge is generated and the claim is filed to the dental payer, then the program ends 150.

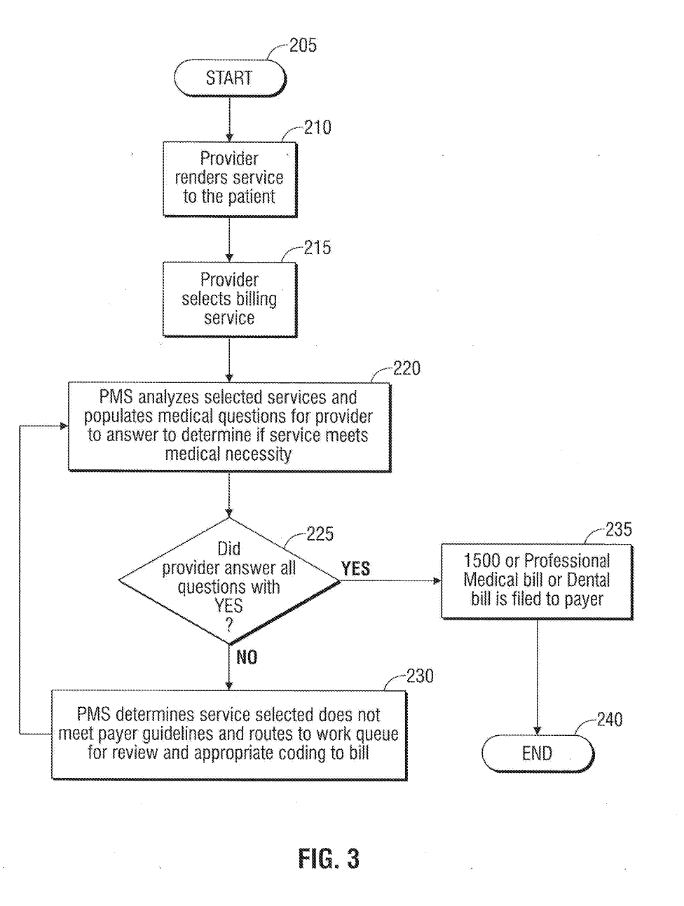

FIG. 3 illustrates one embodiment of the present invention. As shown, the inventive process 300 commences 205 when a provider renders service to a patient 210. Subsequent to this, step the provider selects a billing service 215. In several embodiments after this step, the System Database analyzes the selected service and populated medical questions for provider to answer to determine if service meets medical necessity 220.

In many embodiments, if the provider answers all questions with “yes” 225, then medical bill or dental bill is filed to payer 235, at this point then the process stops 240. In some embodiments, if the user did not provide a “yes” answer for all questions 225, then System Database determines service selected does not meet payer guidelines and routes to work queue for review and appropriate coding to bill 230. At this point the process cycle the System Database analyzes the selected service and populated medical questions for provider to answer to determine if service meets medical necessity 220 is repeated.

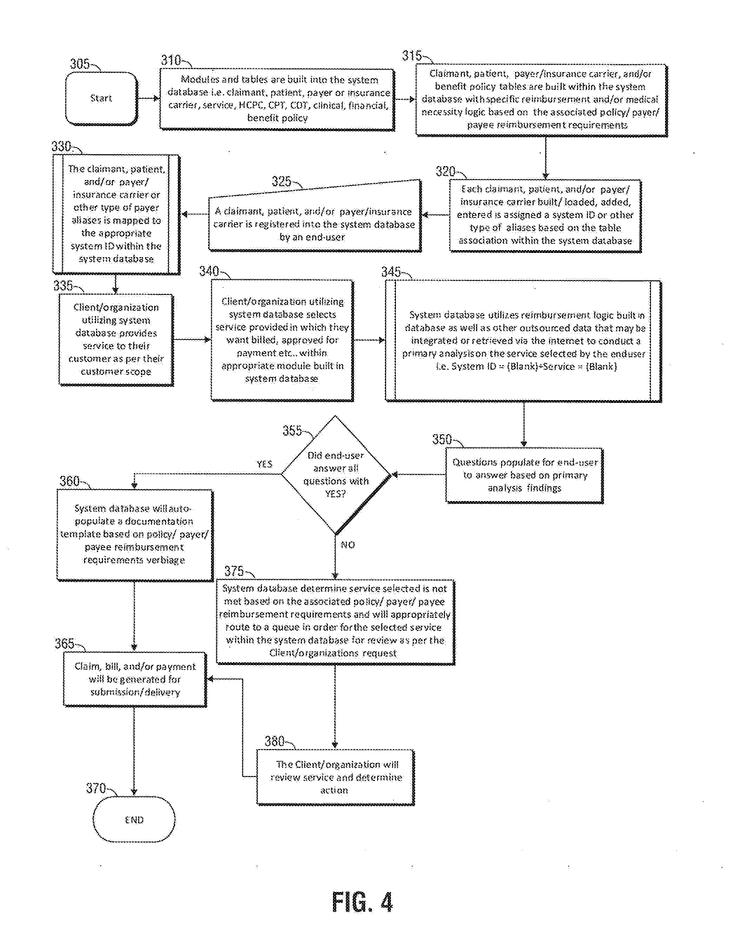

As shown in FIG. 4, in several embodiments the present invention operates as follows: The inventive process starts 305. At this time, modules and tables are built into the system database i.e. claimant, patient, payer or insurance carrier, service, HCPC, CPT, CDT, clinical, financial, benefit policy 310. In several embodiments, next, patient, payer/insurance carrier, and/or benefit policy tables are built within the system database with specific reimbursement and/or medical necessity logic based on the associated policy/payer/payee reimbursement requirements 315. Each claimant, patient, and/or payer/insurance carrier built/loaded, added, entered is assigned a system ID or other type of aliases based on the table association within the system database 320. A claimant, patient, and/or payer/insurance carrier is registered into the system database by an end-user 325. The claimant, patient, and/or payer/insurance carrier or other type of payer aliases is mapped to the appropriate system II) within the system database 330. Client/organization utilizing system database provides service to their customer as per their customer scope 335. Client/organization utilizing system database selects service provided in which they want billed, approved for payment etc. . . . within appropriate module built in system database 340. The system database utilizes reimbursement logic built in database as well as other outsourced data that may be integrated or retrieved via the internet to conduct a primary analysis on the service selected by the end-user i.e. System ID=(Blank)+Service=(Blank) 345. Then questions populate for end-user to answer based on primary analysis findings 350.

If the end-user answers all questions with “yes” 355, then the system database will auto-populate a documentation template based on policy/payer/payee reimbursement requirements verbiage 360. A claim, bill, and/or payment will be generated for submission/delivery 365. The program will then end 370. If the system database determines service selected is not met based on the associated policy/payer/payee reimbursement requirements and will appropriately route to a queue in order for the selected service within the system database for review as per the Client/organizations request 375. The Client/organization will review service and determine action 380 (as is known in the art) and a claim, bill, and/or payment will be generated for submission/delivery 365. The system will then end 370.

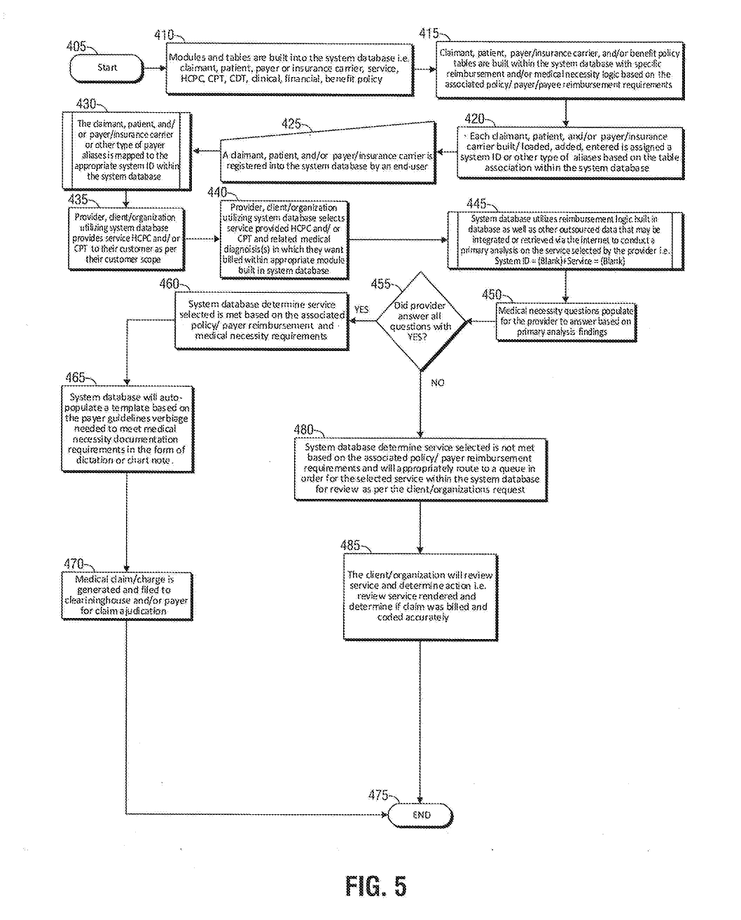

As shown in FIG. 5, several embodiments of the present invention operate as follows: The inventive process starts 405. Next, modules and tables are built into the system database i.e. claimant, patient, payer or insurance carrier, service, HCPC, CPT, CDT, clinical, financial, benefit policy 410. Next, claimant, patient, payer/insurance carrier, and/or benefit policy tables are built within the system database with specific reimbursement and/or medical necessity logic based on the associated policy/payer/payee reimbursement requirements 415. Each claimant, patient, and/or payer/insurance carrier built/loaded, added, entered is assigned a system ID or other type of aliases based on the table association within the system database 420. A claimant, patient, and/or payer/insurance carrier is registered into the system database by an end-user 425. The claimant, patient, and/or payer/insurance carrier or other type of payer aliases is mapped to the appropriate system ID within the system database 430. Provider, client/organization utilizing system database provides service HCPC and/or CPT to their customer as per their customer scope 435. Provider, client/organization utilizing system database selects service provided HCPC and/or CPT and related medical diagnosis(s) in which they want billed within appropriate module built in system database 440. System database utilizes reimbursement logic built in database as well as other outsourced data that may be integrated or retrieved via the internet to conduct a primary analysis on the service selected by the provider i.e. System ID=(Blank)+Service=(Blank) 445. Medical necessity questions populate for the provider to answer based on primary analysis findings 450.

In several embodiments, if the provider answers all questions with YES 455, then system database determine service selected is met based on the associated policy/payer reimbursement and medical necessity requirements 460. Next the system database will auto-populate a template based on the payer guidelines verbiage needed to meet medical necessity documentation requirements in the form of dictation or chart note 465. A medical claim/charge is generated and filed to clearing house and/or payer for claim adjudication 470. The program in then ended 475. In several embodiments, if the questions are answered “no” then system database determine service selected is not met based on the associated policy/payer reimbursement requirements and will appropriately route to a queue in order for the selected service within the system database for review as per the client/organizations request 480. Next, the client/organization will review service and determine action i.e. review service rendered and determine if claim was billed and coded accurately 485. The program will then end 475.

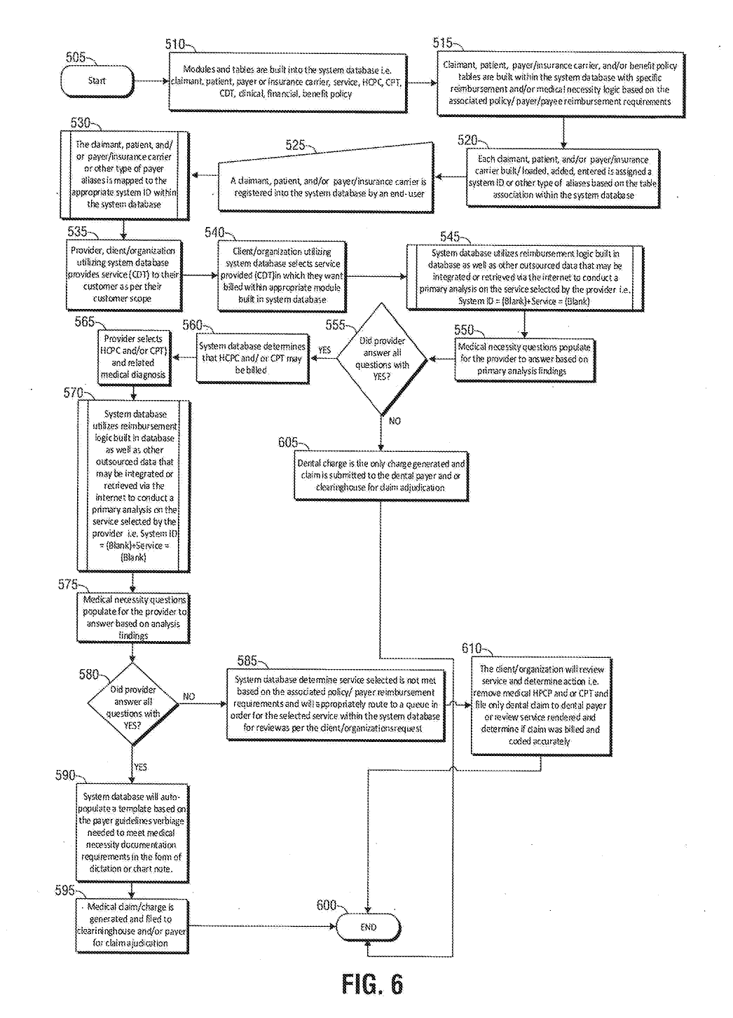

In several embodiments, the present invention operates as illustrated in FIG. 6. The inventive process starts 505. Next, modules and tables are built into the system database i.e. claimant, patient, payer or insurance carrier, service, HCPC, CPT, CDT, clinical, financial, benefit policy 510. Next claimant, patient, payer/insurance carrier, and/or benefit policy tables are built within the system database with specific reimbursement and/or medical necessity logic based on the associated policy/payer/payee reimbursement requirements 515. Each claimant, patient, and/or payer/insurance carrier built/loaded, added, entered is assigned a system ID or other type of aliases based on the table association within the system database 520. A claimant, patient, and/or payer/insurance carrier is registered into the system database by an end-user 525. The claimant, patient, and/or payer/insurance carrier or other type of payer aliases is mapped to the appropriate system ID within the system database 530. Provider, client/organization utilizing system database provides service (CDT) to their customer as per their customer scope 535. Client/organization utilizing system database selects service provided (CDT) in which they want billed within appropriate module built in system database 540. System database utilizes reimbursement logic built in database as well as other outsourced data that may be integrated or retrieved via the internet to conduct a primary analysis on the service selected by the provider i.e. System ID=(Blank)+Service=(Blank) 545. Medical necessity questions populate for the provider to answer based on primary analysis findings 550.

In several embodiments if a provider answered all questions with YES 555. Then system database determines that HCPC and/or CPT may be billed 560. Then the provider selects HCPC and/or CPT) and related medical diagnosis 565. System database utilizes reimbursement logic built in database as well as other outsourced data that may be integrated or retrieved via the internet to conduct a primary analysis on the service selected by the provider i.e. System ID=(Blank)+Service=(Blank) 570. Next, medical necessity questions populate for the provider to answer based on analysis findings 575.

Next if the provider answers all questions to analysis finding 575 with “yes” 580, system database will auto-populate a template based on the payer guidelines verbiage needed to meet medical necessity documentation requirements in the form of dictation or chart note 590. Medical claim/charge is generated and filed to clearing house and/or payer for claim adjudication 595. The program will then end 600.

In several embodiments if a provider did not answer all questions with “yes” 555, then dental charge is the only charge generated and claim is submitted to the dental payer and or clearinghouse for claim adjudication 605. The program will then end 600.

If the provider answers all questions to analysis finding 575 with “yes” then system database determine service selected is not met based on the associated policy/payer reimbursement requirements and will appropriately route to a queue in order for the selected service within the system database for review as per the client/organizations request 585. The client/organization will review service and determine action i.e. remove medical HPCP and or CPT and file only dental claim to dental payer or review service rendered and determine if claim was billed and coded accurately 610. The program will then end 600.

In several embodiments, the present invention is a tool that conducts a primary analysis of a medical or dental claim/encounter without the use of EDI transactions or clearinghouse to ensure payer reimbursement requirements and medical necessity are met. This is achieved by leveraging and embedding payer provider manual guidelines, NCCI edits, LCDs NCDs and creating payer logic/code within the System Database to ensure all payer requirements/verbiage is utilized and optimized to meet payer specific reimbursement and medical necessity requirements. System Database utilize tables in order to store information and build systematic functions and logic. Each payer or insurance carrier is entered/loaded/added or “built” into the Insurance/Payor Table that is housed in the System Database.

In several embodiments of the present invention, each payer or insurance carrier is mapped to an Insurance/Payor ID or other type of payer aliases within a system database. Each Insurance/Payor ID has payer specific reimbursement and medical necessity requirements entered/loaded/added or “built” into a separate table within the System Database that will provide payer specific reimbursement and medical necessity requirements. These payer specific reimbursement and medical necessity requirements are based as per the payer reimbursement and medical necessity guidelines outlined in their Provider Manual, these payer specific reimbursement and medical necessity requirements can be modified, deleted or updated in order to reflect the most current Payer Provider Manual reimbursement and medical necessity requirements as outlined by the payer. During patient registration, the following data elements are captured and entered into the System Database: Patient Demographics i.e. patient's name, date of birth, social security number, address, telephone number. Insurance/Payer Information i.e. insurance carrier identification number, policy number, member ID, group number, subscriber number, subscriber name, subscriber relationship, claim submission address, insurance carrier/payer phone number and insurance carrier/payer address.

In several embodiments, once patient registration is completed the insurance/payor entered is mapped to the appropriate Insurance/Payor ID or other type of payer aliases within the system database. Once the provider has rendered services to the patient, the provider will select the service(s) (CDT/CPT/HCPC) rendered in which they want billed. Each service is mapped to the payer reimbursement and medical necessity requirements logic/code in the system database. The healthcare provider will then need to answer medical necessity questions based on the associated payer. If the service selected to be billed is a dental service and identified within the present invention as a service that qualifies as a service that can be billed to the medical insurance/payer, medical necessity questions will auto-populate.

In several embodiments, based on the answers provided by the provider the present invention will determine if the service selected meets or does not meet payer reimbursement requirements and medical necessity and will either generate a medical or dental or both claims depending on what the provider selected as their rendered billable service. This process is completed by conducting a primary analysis of a medical or dental claim/encounter without the use of EDI transactions or clearinghouse. Depending on the primary analysis results the invention will either generate a medical or dental claim depending on what the provider selected as their rendered billable service. If the claim/encounter meets payer reimbursement requirements and medical necessity the tool will auto-populate a template based on the payer guidelines verbiage needed to meet medical necessity documentation requirements in the form of dictation or chart note.

In several embodiments, this dictation or template will then become a component of the patient's legal medical record and a claim will be generated and submitted to the clearinghouse or payer for claim adjudication. If a claim is not generated the invention will appropriately route the encounter within the system data base for review and appropriate coding on the selected rendered billable service.

In some embodiments, it is an object of the present invention to increase revenue, decrease overhead and optimize an organization's system data base and improve organizations manual processes and operations.

In one embodiment of the present invention, an embedded primary analysis of a medical or dental claim/encounter is conducted without the use of EDI transactions or a clearinghouse to ensure payer reimbursement requirements and medical necessity are met.

In one embodiment, the object of the present invention is to assist dental providers in determining if a medical HCPC or CPT can be billed to the medical payer in addition or in substitute to the billed dental service submitted to the dental payer. In another embodiment of the present invention, the invention generates a series of questions a provider must answer once they have selected the rendered billable service they have performed on their patient. Based on the providers answers the present invention will determine if the service selected meets, or does not meet, payer reimbursement requirements and medical necessity and will either generates a medical or dental claim for submission to the clearinghouse or payer for claim adjudication or will route the encounter appropriately within the system data base for review and appropriate coding on the selected rendered billable service.

In one embodiment of the present invention, if the claim/encounter meets payer reimbursement requirements and medical necessity the tool will also auto-populate a template based on the payer guidelines verbiage needed to meet medical necessity documentation requirements in the form of dictation or chart note.

While preferred embodiments have been shown, and described, modifications thereof can be made by one skilled in the art without departing from the scope or teaching herein. The embodiments described herein are exemplary only and are not limiting. Many variations and modifications of the system and apparatus are possible and will become apparent to those skilled in the art once the above disclosure is fully appreciated. For example, the relative dimensions of various parts, the materials from which the various parts are made, and other parameters can be varied. Accordingly, it is intended that the following claims be interpreted to embrace all such variations and modifications.

I claim:

1. An improved billing system and method comprising the steps of:
rendering service from a provider to a patient;
selecting the billing from the CPT/HCPC by a provider;
utilizing a system data base to analyze selected CPT/HCPC and populate medical questions for a provider to answer to determine if said service meets a medical necessity.

2. The method of claim 1 further comprising the step of:
answering all populated medical questions with “yes,” and
filing a medical bill to the medical payer.

3. The method of claim 1 further comprising the step of:
answering at least one populated medical questions with “no”;
determining by the system database that the CPT/HCPC selected does not meet payer guidelines;
rerouting to the work que for review and appropriate coding to bill;
utilizing a system database to analyze selected CPT/HCPC and populate medical questions for a provider to answer to determine if said service meets a medical necessity;
repeating said steps until answering all populated medical questions with “yes,” and
filing a medical bill to the medical payer.

4. An improved billing system and method comprising the steps of:
rendering service from a provider to a patient;
selecting by the provider the billing from the CPT;
analyzing by the system database of the selected CPT and populating medical questions for provider to answer to determine if a medical HCPC/CPT can be billed in addition to CDT.

5. The improved method of claim 4 with the further step comprising:
answering by the provider of all medical questions with “yes”;
populating the HCPC/CPT to provide to select service performed;
selection of CPT/HCPC for medical service provider and medical bill is filed to medical payer; and
generating the dental charge and claim is filed to dental payer.

6. The improved method of claim 4 with the further step comprising:
answering at least one of the questions with “no”; and
generating the dental charge and the claim is filed to dental payer.

7. An improved billing system and method comprising the steps of:
rendering service to a patient from a provider;
selecting a billing service by the provider;
analyzing by the system database of the selected service and populating medical questions for provider to answer to determine if service meets medical necessity.

8. The improved method of claim 7 with the further step comprising:
answering all questions with “yes”; and
filing professional medical bill or dental bill to payer.

9. The improved method of claim 7 with the further step comprising:
answering at least one question “no”;
determining by the system database if the service selected does not meet payer guidelines and routes to work queue for review and appropriate coding to bill; and
analysis of process cycles the system database of the selected service and populated medical questions for provider to answer to determine if service meets medical necessity.
